(19) United States
(12) Patent Application Publication
(10) Pub. No.: US 2015/0324868 A1
(43) Pub. Date: Nov. 12, 2015

(54) Query Categorizer

(71) Applicant: Quixey, Inc., Mountain View, CA (US)

(72) Inventors: Tomer Kaftan, Los Altos, CA (US); Michael Avrukin, Palo Alto, CA (US); James Delli Santi, San Jose, CA (US)

(73) Assignee: Quixey, Inc., Mountain View, CA (US)

(21) Appl. No.: 14/275,766

(22) Filed: May 12, 2014

(51) Int. Cl. G06Q 30/02; G06F 17/30

(52) U.S. Cl. CPC G06Q 30/0277; G06F 17/30864; G06F 17/3053; G06F 17/30598

(57) ABSTRACT

A system and method for receiving, by one or more processing devices, a search query containing one or more query terms from a remote computing device; determining, by the one or more processing devices, a query categorization of the search query based on one or more relevant query terms of the one or more query terms, the query categorization being indicative of one or more application categories to which the search query likely pertains; generating, by the one or more processing devices, an advertisement based on the query categorization; encoding, by the one or more processing devices, the advertisement in search results; and providing, by the one or more processing devices, the search results to the remote computing device.

### TECHNICAL FIELD

This disclosure relates to the field of search in computing environments. In particular, this disclosure relates to methods and systems for determining a query categorization of a search query.

### BACKGROUND

Search result pages (which are produced by a search system) provide advertisers with a medium to advertise websites or other services. Typically, an advertiser can register one or more keywords and an advertisement with a company that provides the service of the search and/or provides the search result page, such that when a search system user includes the one or more keywords in a search query, the search system may also include the advertisements corresponding to the one or more keywords in the search result page. The search system can sell the keywords according to different advertising schemes, including cost per number of impressions, cost per click-through, and cost per action. According to the cost per number of views model, the advertiser agrees to pay a specified amount each time the advertisement is displayed X number of times on a result page in response to a relevant search query. According to the cost per click-through model, the advertiser agrees to pay a specified amount each time a user clicks on the advertisement, when the advertisement is displayed in response to a relevant search query. According to the cost per action model, the advertiser agrees to pay a specified amount each time a user performs a specific action in response to the advertisement being displayed. For example, the advertiser can agree to pay the specified amount when a user clicks on a hyperlink in the advertisement and makes a purchase from the website associated with the user.

### SUMMARY

The present disclosure relates to determining query categorizations of search queries. A query categorization can be indicative of one or more likely categories to which the search query corresponds. A search system receives a search query from a user device and determines a query categorization of the search query. The search system can generate one or more advertisements based on the query categorization. The search system may also determine organic search results based on the search query. The search system can generate search results based on the organic search results and the advertisements, which it provides the requesting user device.

One aspect of the disclosure provides a method for generating advertisements for inclusion in search results based on a categorization of a query. The method includes receiving, by one or more processing devices, a search query containing one or more query terms from a remote computing device and determining, by the one or more processing devices, a query categorization of the search query based on one or more relevant query terms of the one or more query terms. The query categorization is indicative of one or more application categories to which the search query likely pertains. The method further includes generating an advertisement based on the query categorization, encoding the advertisement in search results and providing the search results to the remote computing device, by the one or more processing devices.

Implementations of the disclosure may include one or more of the following features. In some implementations, the method includes determining, by the one or more processing devices, organic search results indicating one or more applications relevant to the search query and encoding, by the one or more processing devices, the organic search results in the search results. Determining the query categorization may further include identifying the one or more relevant terms from the one or more relevant query terms. For each of the one or more relevant query terms, the method may include determining a term categorization of the relevant query term. Each term categorization indicates one or more frequency ratios respectively corresponding to the one or more application categories. Each frequency ratio is indicative of a degree of likelihood that the relevant query pertains to the corresponding application categories. The method may further include determining the query categorization based on the one or more term categorizations corresponding to the one or more relevant query terms.

In some examples, determining the term categorization of the relevant query term includes calculating the one or more frequency ratios for the relevant query terms based on a number of documents associated with the corresponding application category, a number of documents associated with any application category that contains the relevant term, and a category ratio mapping of the corresponding application category. Additionally or alternatively, determining the plurality of frequency ratios includes, for each of a plurality of application categories including the one or more application categories, retrieving a frequency ratio from a category index. The category index associates each of a plurality of unique terms with the plurality of application categories, and stores a corresponding frequency score for each unique term and application category combination. Determining the query categorization may further include combining the term categorizations of each of the relevant query terms.

In some implementations, generating the advertisement based on the query categorization includes retrieving an advertisement record based on the category categorization and generating the advertisement based on the advertisement content. The advertisement record is associated with an application category of a plurality of application categories and includes advertisement content corresponding to a sponsored subject. Additionally or alternatively, generating the advertisement based on the query categorization may further include identifying one or more application records corresponding to an application category of the one or more categories from a plurality of application records, the application category being the most likely of the one or more application categories to pertain to the search query. Retrieving the advertisement record may further include selecting the advertisement record from the one or more application records based on fee structures of the one or more advertisement records. Each of the plurality of advertisement records may have a fee structure indicating an agreed upon price per event. In some examples, the query categorization includes a plurality of category scores, where each category score of the plurality of category scores respectively corresponds to one or a plurality of application categories and indicates a likelihood that the search query pertains to the corresponding application category.

Another aspect of the disclosure provides a search system including one or more storage devices and one or more processing devices that executes computer readable instructions. When the computer readable instructions are executed by the one or more processing devices, the one or more processing devices receive a search query containing one or more query terms from a remote computing device and determines a query categorization of the search query based on one or more relevant query terms of the one or more query terms. The query categorization may be indicative of one or more application categories to which the search query likely pertains. The one or more processing devices further generate an advertisement based on the query categorization, encode the advertisement in search results and provide the search results to the remote computing device.

In some examples, the computer readable instructions further cause the one or more processing devices to determine organic search results indicating one or more applications relevant to the search query and encodes the organic search results in the search results. Determining the query categorization may further include identifying the one or more relevant terms from the one or more relevant query terms. For each of the one or more relevant query terms, the device further determines a term categorization of the relevant query term. Each term categorization indicates one or more frequency ratios respectively corresponding to the one or more application categories. Each frequency ratio is indicative of a degree of likelihood that the relevant query pertains to the corresponding application categories. The device further determines the query categorization based on the one or more term categorizations corresponding to the one or more relevant query terms. Additionally or alternatively, determining the term categorization of the relevant query term may include calculating the one or more frequency ratios for the relevant query terms based on a number of documents associated with the corresponding application category, a number of documents associated with any application category that contains the relevant term, and a category ratio mapping of the corresponding application category.

In some implementations, the one or more storage devices store a category index that associates each of a plurality of unique terms with a plurality of application categories including the one or more application categories and stores a corresponding frequency score for each unique term and application category combination. Determining the plurality of frequency ratios may include, for each of the plurality of application categories, retrieving a frequency ratio corresponding to the relevant query term from a category index. Determining the query categorization may further include combining the term categorizations of each of the one or more relevant query terms.

In some examples, the one or more storage devices store an advertisement database that stores a plurality of advertisement records. Each advertisement record may be associated with an application category of a plurality of application categories and including advertisement content corresponding to a sponsored subject. Generating the advertisement based on the query categorization may include retrieving an advertisement record from the plurality of advertisement records based on the category categorization and generating the advertisement based on the advertisement content. Retrieving the advertisement record may include identifying one or more application records from the advertisement datastore and selecting the advertisement record from the one or more application records based on fee structures of the one or more advertisement records. Each application record may correspond to an application category of the one or more categories, the application category being the most likely of the one or more application categories to pertain to the search query. Each of the plurality of advertisement records may have a fee structure indicating an agreed upon price per event.

In some examples, the query categorization includes a plurality of category scores. Each category score of the plurality of category scores respectively corresponds to one of a plurality of application categories and indicates a likelihood that the search query pertains to the corresponding application category.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic illustrating an example system for performing searches.

FIG. 1B is a schematic illustrating an example user device displaying search results.

FIG. 1C is a schematic illustrating an example implementation of the search system.

FIGS. 2A-2C are schematics illustrating an example set of components of a search system.

FIG. 2D is a schematic illustrating an example of a category index.

FIG. 2E is a schematic illustrating an example of an advertising index.

FIG. 3 illustrates an example set of operations for a method for processing a search query.

FIG. 4 illustrates an example set of operations for determining a query categorization of a search query.

Like reference symbols in the various drawings indicate like elements.

### DETAILED DESCRIPTION

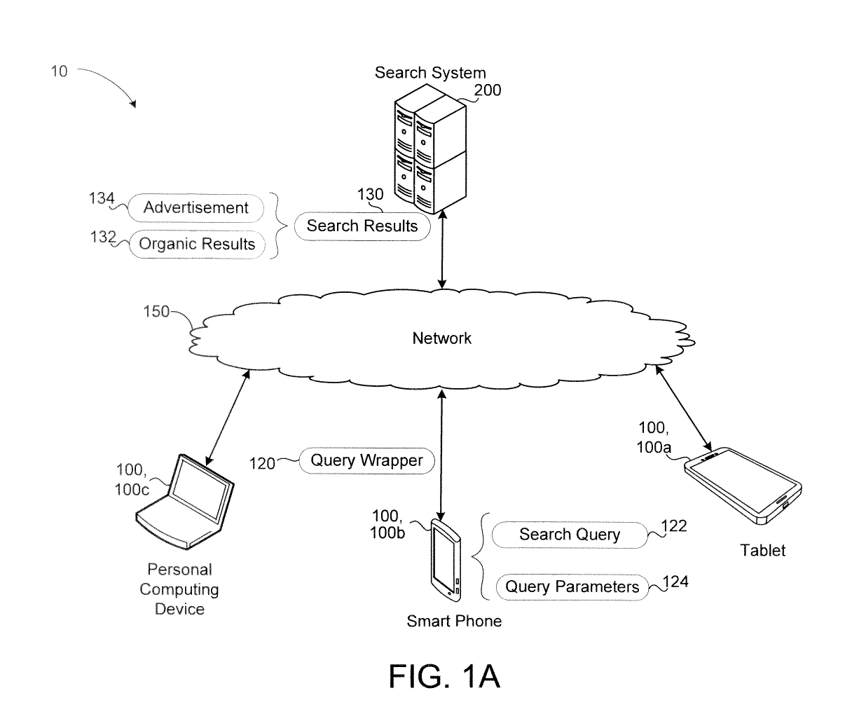

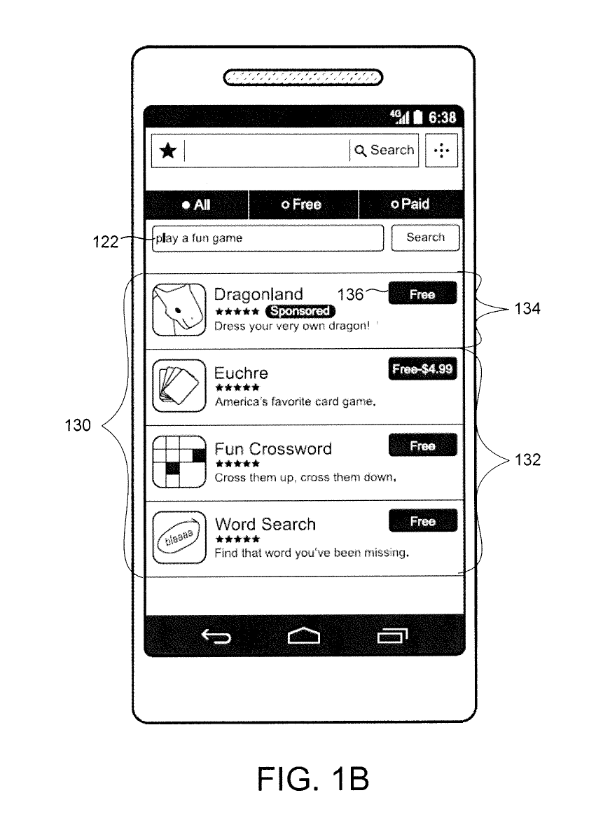

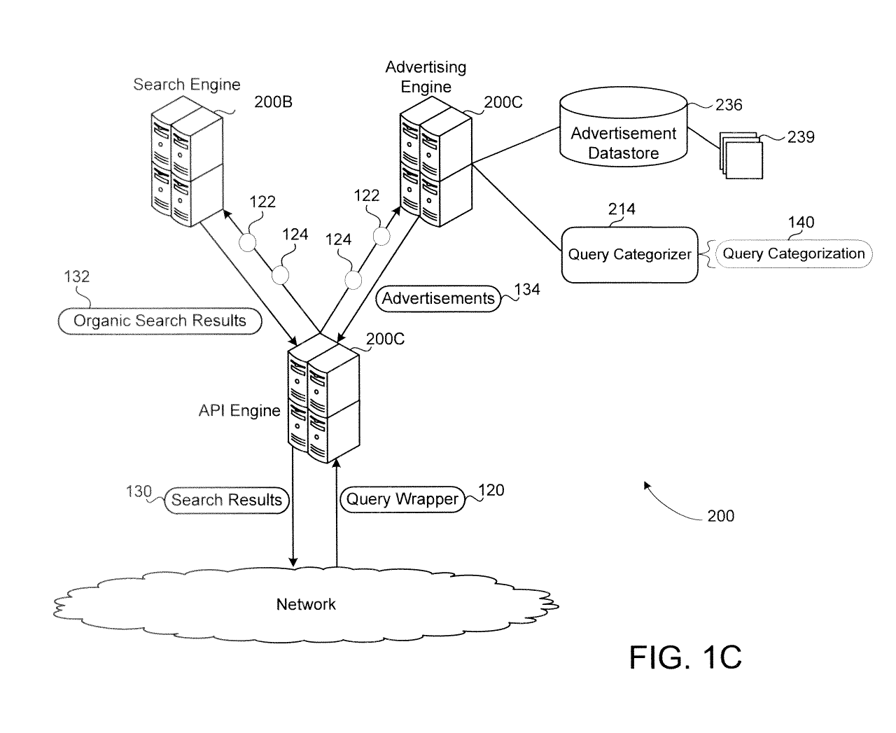

FIG. 1A illustrates an example environment 10 for processing search queries 122. The example environment includes a search system 200 and one or more user devices 100. The search system 200 is a system of one or more computing devices (e.g., server devices) that is configured to receive a search query 122 from a user device 100 and to provide search results 130 to the user device 100 based on the search query 122. The search results 130 can include organic search results 132 and one or more advertisements 134. Organic search results 132 can refer to a listing of items that are relevant to, at least in part, on one or more terms of the search query 122. Examples of organic search results 132 may include, but are not limited to, listings of websites, listings of applications, listings of products, and listings of services. Put another way, a search system 200 determines the organic search results 132 by identifying items that are relevant to the information conveyed in the search query 122 (and in some cases one or more other query parameters 124). An advertisement 134 can refer to a sponsored item that the search system 200 includes into the search results 130 in exchange for consideration (e.g., money). In some implementations, an advertising entity agrees to a fee structure (e.g., to pay a certain amount for a given action). For example, the advertising entity can agree to a per click, per action, or per impression fee structure, whereby when the action (i.e., click, action, or impression) occurs with respect to the sponsored content of the advertising entity, the advertising entity is charged the agreed upon price. An advertising entity can advertise, for example, a website, an application, a product, a service, a political cause, or a political candidate.

According to some implementations, the search system 200 determines one or more advertisements 134 to insert in the search results 130 based on a query categorization 140 of the search query 122. A query categorization 140 can be indicative of one or more likely categories to which the search query 122 corresponds.

In some implementations, the search system 200 is an application search system 200 that performs searches relating to applications. An application can refer to computer readable instructions that cause a computing device (e.g., a user device 100) to perform a task. In some examples, an application may be referred to as an “app.” Example applications include, but are not limited to, messaging applications, media streaming applications, social networking applications, lifestyle applications, organizational applications, and games. Applications can be executed on a variety of different user devices 100. For example, applications can be executed on mobile computing devices, such as smart phones 100b, tablets 100a, and wearable computing devices (e.g., headsets and/or watches). Applications can also be executed on other types of user devices 100 having other form factors, such as laptop computers 100c, desktop computers, or other consumer electronic devices. Some applications may be accessible using a web browser of the user device 100.

Applications can be native applications or web applications. Native applications are applications that are installed on a user device 100. In some examples, native applications may be installed on a user device 100 prior to the purchase of the user device 100. In other examples, a user device 100 may download a native application from a digital distribution platform such as the APP STORE® digital distribution platform developed by Apple Inc. or the GOOGLE PLAY® digital distribution platform developed by Google Inc. In these examples, the user device 100 downloads and installs the application at the request of a user. In some examples, all of a native application's functionality is performed by the user device 100 on which the application is installed. These native applications may function without communication with other computing devices (e.g., via the Internet). In other examples, a native application installed on a user device 100 may access information from a remote computing device (e.g., a server) at runtime. For example, a weather application installed on a user device 100 may access the latest weather information via a remote server and display the accessed weather information to the user through the installed weather application.

In some implementations, states of native applications can be assessed using application resource identifiers (e.g., application URLs). An application resource identifier can refer to a string of numbers, letters, and/or characters that reference the native application and indicate a state of the native application. In some scenarios, a native application uses an application resource identifier to access a state indicated by the application resource identifier.

A web application is an application that may be partially executed by the user's computing device and partially executed by a remote computing device. For example, a web application may be an application that is executed, at least in part, by a web server and accessed by a web browser of the user's computing device. Example web applications may include, but are not limited to, web-based email, online auctions, and online retail sites. In some implementations, states of web applications can be accessed using web resource identifiers (e.g., URLs). In operation, a web browser of a user device 100 accesses a state of a web application using a web resource identifier.

In some implementations, the application search system 200 can perform application searches. An application search is a search for applications that are relevant to the search query 122. In an application search, the organic search results 130 can provide one or more result objects respectively corresponding to one or more applications that are relevant to the search query 122. A result object can contain content relating to the application. For example, if the search query 122 contains the query terms “listen to music,” the search results 130 can include result objects that provide descriptions of various audio streaming/playback applications. In another example, if the search query 122 contains the query terms “addictive games,” the search results 130 can include result objects that can include descriptions of specific popular gaming applications, highly rated gaming applications, and/or games that reviewers have described as “addictive.” In some implementations, the content of a result object corresponding to an application can include a description of the application, one or more screen shots of the application, a rating of the application, one or more reviews of the application, and/or a link to a digital distribution platform to download the application.

The search system 200 is further configured to generate one or more advertisements 134 that it includes in the search results 130. In operation, advertising entities provide advertisement content to the search system 200. The search system 200 generates advertisements 134 based on the advertisement content. The advertising entity further agrees to a fee structure, whereby the advertising entity agrees to exchange consideration (e.g., money) each time an agreed upon event is performed with respect to the advertisement 134. For example, each time a particular advertisement 134 is presented in the search results 130 at a user device 100, the advertising entity may agree to pay two cents (i.e., pay-per-impression). Similarly, the advertising entity may agree to pay ten cents each time a particular advertisement 134 is selected (e.g., clicked on or pressed on) by the user of the user device 100 (i.e., pay-per-click).

In order to better target the advertisement 134 to users, the advertising entity associates the advertisement 134 or advertisement content with one or more categories. In some implementations, the categories that the advertiser can choose from are categories of applications. For instance, the categories may include “lifestyle apps,” “popular games,” “fantasy sports apps,” “video streaming apps,” “internet radio apps,” “banking apps,” “children's games,” “book reader apps,” and any other suitable application designation. An advertising entity 130 selects one or more categories and agrees to a fee structure regarding the advertisement 134. In some scenarios, the advertising entity provides the advertisement content. With respect to the fee structure, the advertising entity can agree to pay a specified amount per event (e.g., click, impression, or action) and can define a maximum amount to be charged over a certain time (e.g., no more than $500.00 per day, or $10,000 a month). In some implementations, the advertising entity provides a “bid” on one or more of the categories (e.g., the advertising entity agrees to pay ten cents per click for lifestyle apps). Additionally or alternatively, a party affiliated with the search system 200 (e.g., the owner of the search system 200) can set the fee structure for each category (e.g., the cost to advertise on popular games is fifteen cents a click). After the advertising entity has provided the advertisement content, selected the categories, and agreed to the fee structure, the search system 200 can generate an advertisement 134 based on the advertisement content and can begin including the advertisement 134 in the search results 130 in accordance with the fee structure.

In operation, a user device 100 receives a search query 122 from a user via a user interface of the device 100. A search query 122 can include one or more query terms. The user, for example, can provide the query terms by typing text containing the query terms via a touch screen keyboard or can provide speech input containing the query terms via a microphone of the user device 100. In the latter scenario, the user device 100 can perform speech-to-text conversion to identify the query terms. In some implementations, the user device 100 can generate a query wrapper 120 that contains the search query 122. A query wrapper 120 is a data unit that is communicated to the search system 200 via a network 150. The query wrapper 120 can further include one or more query parameters 124. For example, a query wrapper 120 can include query parameters 124 that indicate one or more of a geolocation of the user device 100, a username associated with the device 100, and an operating system of the user device 100. In some implementations a search application executing on the user device 100 receives the search query 122 (e.g., via a graphical user interface of the search application or via a search bar), determines zero or more query parameters 124, generates the query wrapper 120 based on the search query 122 and the query parameters 124, and transmits the query wrapper 120 to the search system 200. The

The search system 200 receives and processes the query wrapper 120. The search system 200 generates the organic search results 132 based on the contents of the query wrapper 120. For example, the search system 200 can perform an application search to determine the organic search results 132. The search system 200 includes the organic search results 132 in the search results 130.

The search system 200 also generates one or more advertisements 134 to include in the search results 130. The search system 200 can include a query categorizer 214 that determines a query categorization of the search query 122 based on the query terms contained in the search query 122. In some implementations, the categories to which a query can belong are application categories (e.g., lifestyle apps, popular games, finance apps, or social networking apps). A query categorization can refer to a linear combination that defines the categories to which the search query 122 can correspond, and the likelihood that the search query 122 corresponds to each category. For example, the query categorization can be defined as:

Categorization=w₁C₁+w₂C₂+ . . . w_{N}C_{N} (1)

where Categorization is the query categorization, Cᵢ is the ith category and wᵢ is a category score (i.e., a weight) that indicates a likelihood that the search query 122 pertains to the ith category. In some implementations, the category score is normalized from 0 to 1. For example, a search query 122 containing the terms “organize my life” may have a query categorization, 0.7 (lifestyle apps)+0.4 (accounting apps)+ . . . +0.0001 (popular games), such that the category score of lifestyle apps is 0.7, the category score of accounting apps is 0.4, and the category score of popular games is 0.0001. In this example, lifestyle apps and accounting apps appear to be the most likely categories of the search query 122. In other implementations, the search system 200 selects the category having the highest category score indicated in equation (1) as the query categorization 140 or any categories having a category score greater than a threshold (e.g., 0.75). Additionally or alternatively, the query categorization can be represented by a vector, whose elements represent the different categories and the values stored in the elements are the category scores of the respective categories.

The search system 200 selects one or more advertisement records 239 from an advertisement datastore 236 based on the query categorization and generates one or more advertisements 134 based on the advertisement records 239. The search system 200 includes the generated advertisements 134 in the search results 130. The search system 200 can then transmit the search results 130 to the user device 100. The user device 100 can display the search results 130 via its user interface (e.g., touchscreen or monitor). In some implementations, the user device 100 renders the search results 130. Alternatively, the search system 200 can render the search results 130.

FIG. 1B illustrates an example of a user device 100 displaying search results 130 corresponding to the search query “play a fun game.” In the illustrated example, the search results 130 include an advertisement 134 that advertises an example application called Dragon Land. The user can select the advertisement 134 by, for example, pressing on an area of the screen displaying the advertisement 134. By selecting the advertisement 134, the user may be directed to an entry of the advertised application. The entry may include, for example, a description of the advertised application, one or more screen shots of the advertised application, and a link to the digital distribution platform whereby the user can opt to download the advertised application from the digital distribution platform. In the illustrated example, the advertisement 134 includes an icon 136 that is a link to the digital distribution platform. Should the user desire to download the advertised application, the user can select the icon 136 to launch the digital distribution platform. The advertisement 134 illustrated in FIG. 1B is provided for example only. The advertisement 134 may be arranged in any suitable manner and the advertisement 134 can advertise any suitable subject matter (e.g., a website, an application, a political cause, etc.).

FIG. 1C illustrates an example implementation of the search system 200. In the illustrated example, the search system 200 includes an application program interface (“API”) engine 200C, a search engine 200A, and an advertising engine 200B.

The API engine 200C receives query wrappers 120 from one or more user devices 100 via the network 160. The API engine 200C parses a query wrapper 120 to identify the search query 122 and, potentially, one or more query parameters 124. The API engine 200C calls the search engine 200A and the advertising engine 200B by providing the search query 122 and the query parameters 124 to the respective engines 200A, 200B.

The search engine 200A receives the search query 122 and the query parameters 122 and performs an application search based thereon. Examples of an application search are discussed further below. The search engine 200A outputs the organic search results 132 to the API engine 200C.

The advertisement engine 200B receives the search query 122 and the query parameters 122 and generates zero or more advertisements based thereon. An example advertisement engine 200B is described in further detail below. The advertisement engine 200B outputs any generated advertisements 134 to the API engine 200C.

The API engine 200C receives the organic search results 132 and any generated advertisements 134 and generates the search results 130 based on thereon. In some implementations, the API engine 200C generates code that includes the organic search results 132 and the generated advertisements 134. The API engine 200C transmits the code to a user device 100 which provided the search query 122. In these implementations, the user device 100 executes the code to render and display the search results. Alternatively, the API engine 200C can render the search results 130 and can provide the rendered search results to the user device 100, which in turn displays the search results 130.

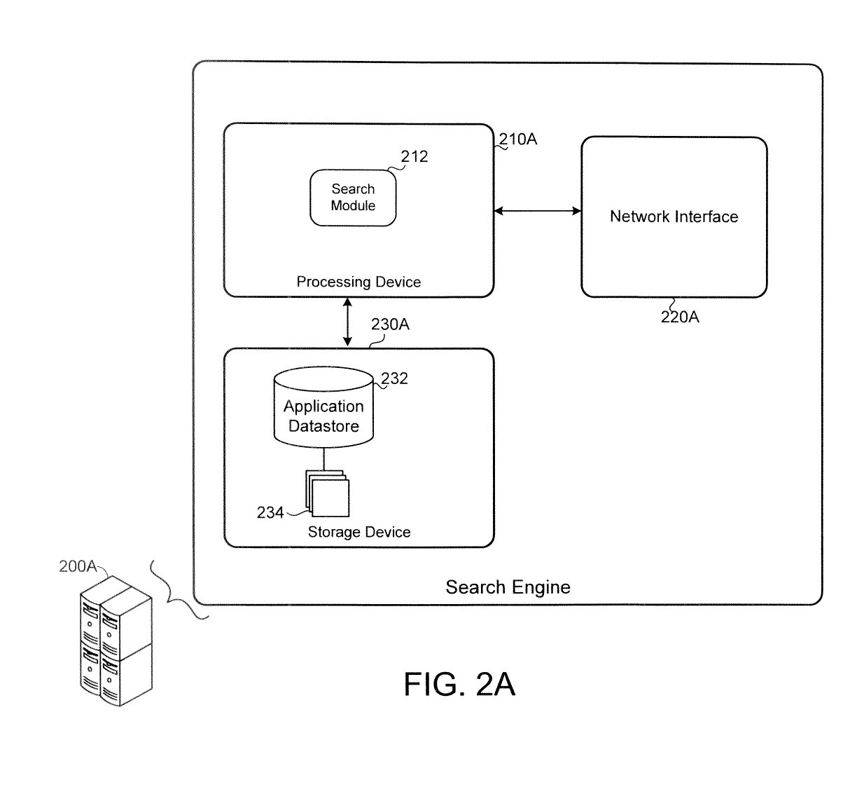

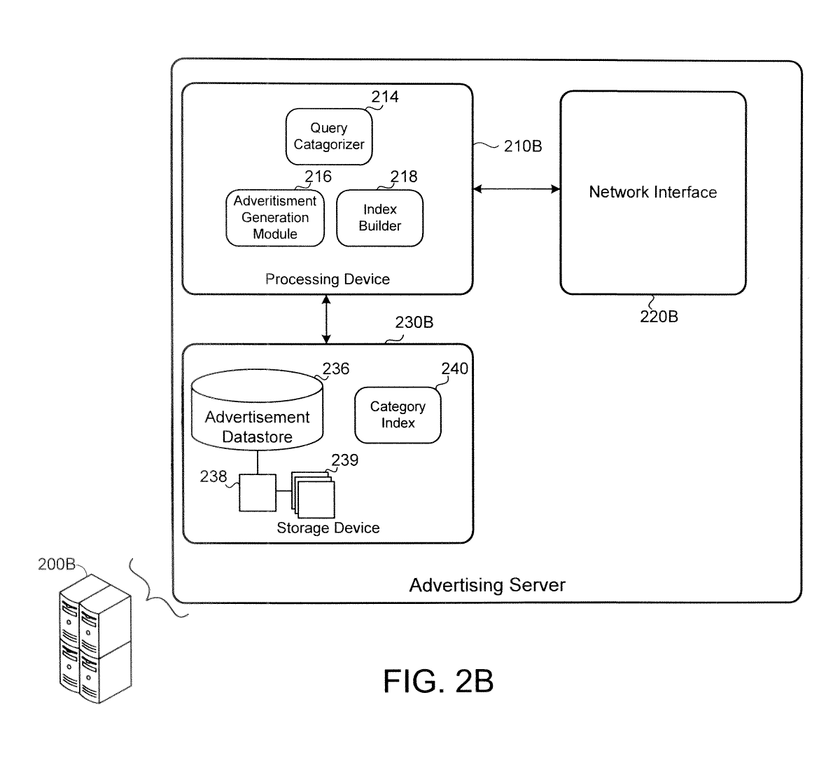

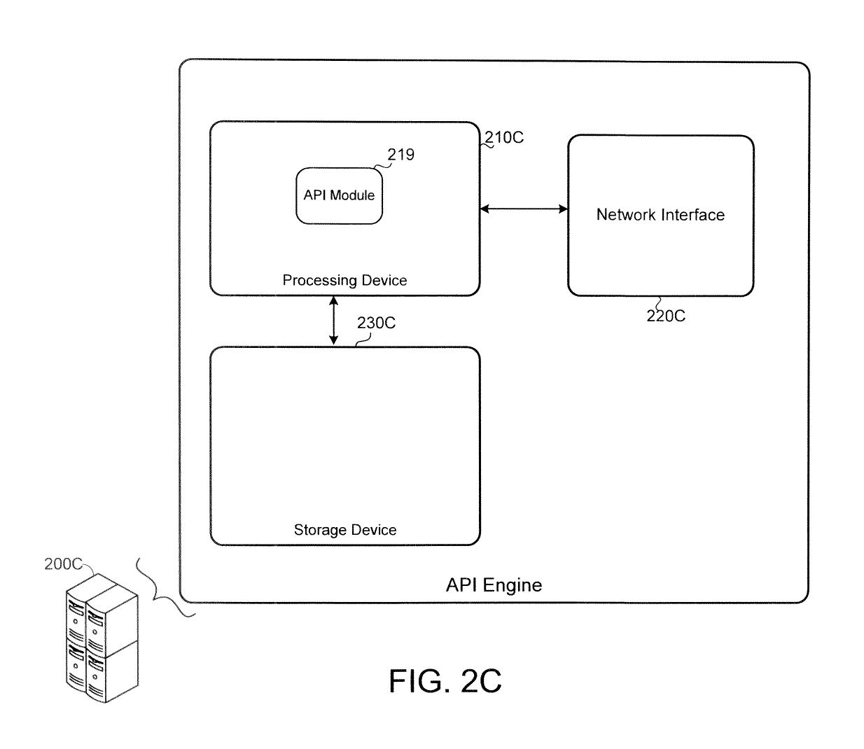

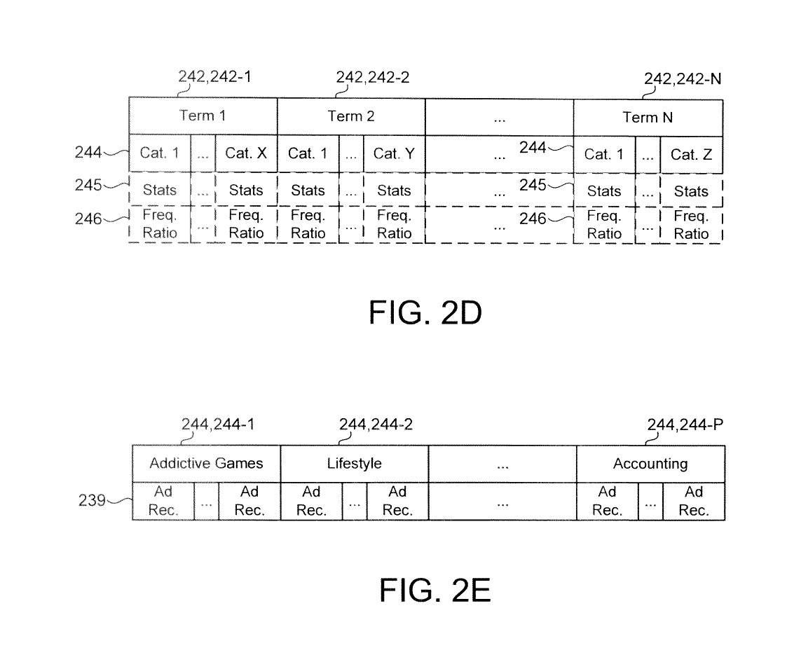

FIG. 2A-2C illustrate an example set of components of a search system 200. FIG. 2A illustrates example components of a search engine 200A, FIG. 2B illustrates example components of the advertising engine 200B, and FIG. 2C illustrates example comonents of the API engine 200C. The advertisement engine 200B is configured to generate advertisements 134 for insertion into search results 130 based on a query categorization 140 of a received search query 122. The search system 200 may be implemented as a single computing device or a plurality of computing devices that operate in a distributed or individual manner. The search engine 200A and the advertisement engine 200B can each include, but are not limited to, a processing device 210A, 210B, a network interface device 220A, 220B, and a storage device 230A, 230B. In some implementations, the search engine 200A, the application engine 200B, and the API engine 200C can share resource, e.g, a processing device 210 and/or a storage device 230. In other implementations, each respective engine 200A, 200B, 200C includes its own components.

A processing device 210 can include memory (e.g., RAM and/or ROM) that stores computer readable instructions and one or more physical processors that execute the computer readable instructions. In implementations where the processing device 210 includes more than one processor, the processors can operate in an individual or distributed manner. Furthermore, in these implementations the processors can be in the same computing device or can be implemented in separate computing devices (e.g., rack-mounted servers). The processing device 210A of the search engine 200A can execute a search module 212. The processing device 210B of the advertisement engine 200B can execute a query categorizer 214, an advertisement generation module 216, and an index builder 218. The processing device 210C of the API engine 200C can execute an API module 219.

A network interface device 220 includes one or more devices that can perform wired or wireless (e.g., WiFi or cellular) communication. Examples of the network interface device 220 include, but are not limited to, a transceiver configured to perform communications using the IEEE 802.11 wireless standard, an Ethernet port, a wireless transmitter, and a universal serial bus (USB) port.

A storage device 230 can include one or more computer readable storage mediums (e.g., hard disk drives and/or flash memory drives). The storage mediums can be located at the same physical location or at different physical locations (e.g., different server and/or different data centers). The storage device 230A of the search engine 200A can store an application datastore 232. The storage device 230B of the advertisement engine 200B can store an advertisement datastore 236, and one or more category indexes 240.

The search module 212 receives a search query 122 from, for example, the API engine 200C (e.g., from the API module 219), and generates the organic search results 132 based thereon. The search module 212 can perform any suitable type of search to identify organic search results 132. For example, the search module 212 can perform an application search. The search module 212 provides the organic search results 132 to the API module 200C.

The search module 212 can utilize the application data store 232 during an application search. The application datastore 232 may include one or more databases, indices (e.g., inverted indices), files, or other data structures storing this data. The application datastore 232 includes application data of different applications. The application data of an application may include keywords associated with the application, reviews associated with the application, the name of the developer of the application, the platform of the application, the price of the application, application statistics (e.g., a number of downloads of the application and/or a number of ratings of the application), a category of the application, and other information. The application datastore 232 may include metadata for a variety of different applications available on a variety of different operating systems.

In some implementations, the application datastore 232 stores the application data in application records 234. Each application record 234 can correspond to an application and may include the application data pertaining to the application. An example application record 234 includes an application name, an application identifier, and other application features. The application record 234 may generally represent the application data stored in the application datastore 232 that is related to an application.

The application name may be the trade name of the application represented by the data in the application record 234. Example application names may include “FACEBOOK®” owned by Facebook, Inc., “TWITTER®” owned by Twitter, Inc., and/or “MICROSOFT WORD®” owned by Microsoft Corp. The application identifier (hereinafter “application ID”) identifies the application record 234 amongst the other application records 234 included in the application datastore 232. In some implementations, the application ID may uniquely identify the application record 234. The application ID may be a string of alphabetic, numeric, and/or symbolic characters (e.g., punctuation marks) that uniquely identify the application represented by the application record 234. In some implementations, the application ID is a unique ID that the digital distribution platform that offers the application assigns to the application. In other implementations, the search system 200 assigns application IDs to each application when creating an application record 234 for the application.

The application features may include any type of data that may be associated with the application represented by the application record 234. The application features may include a variety of different types of metadata. For example, the application features may include structured, semi-structured, and/or unstructured data. The application features may include information that is extracted or inferred from documents retrieved from other data sources (e.g., digital distribution platforms, application developers, blogs, and reviews of applications) or that is manually generated (e.g., entered by a human). The application features may be updated so that up to date results can be provided in response to a search query 122.

The application features may include the name of the developer of the application, a category (e.g., genre) of the application, a description of the application (e.g., a description provided by the developer), a version of the application, the operating system the application is configured for, and the price of the application. The application features further include feedback units provided to the application. Feedback units can include ratings provided by reviewers of the application (e.g., four out of five stars) and/or textual reviews (e.g., “This app is great”). The application features can also include application statistics. Application statistics may refer to numerical data related to the application. For example, application statistics may include, but are not limited to, a number of downloads of the application, a download rate (e.g., downloads per month) of the application, and/or a number of feedback units (e.g., a number of ratings and/or a number of reviews) that the application has received. The application features may also include information retrieved from websites, such as comments associated with the application, articles associated with the application (e.g., wiki articles), or other information. The application features may also include digital media related to the application, such as images (e.g., icons associated with the application and/or screenshots of the application) or videos (e.g., a sample video of the application).

The search module 212 receives a query wrapper 120 that contains a search query 122 and in some scenarios, one or more query parameters 124. The search module 212 may perform various analysis operations on the search query 122. For example, analysis operations performed by the search module 212 may include, but are not limited to, tokenization of the search query 122, filtering of the search query 122, stemming the search query 122, synonomyzation of the search query 122, and stop word removal. In some implementations, the search module 212 may further generate one or more reformulated search queries based on the search query 122 and the query parameters 124. Reformulated search queries are search queries that are based on some sub-combination of the search query 122 and the query parameters 124.

In some implementations, the search module 212 identifies a consideration set of applications (e.g., a list of applications) based on the search query 122 and, in some implementations, the reformulated queries. In some examples, the search module 212 may identify the consideration set by identifying applications that correspond to the search query 122 or the reformulated search queries based on matches between terms of the query 122 and terms in the application data of the application (e.g., in the application record 234 of the application). For example, the search module 212 may identify one or more applications represented in the application datastore 232 based on matches between tokens representing the terms of the search query 122 and words included in the application records 234 of those applications. The consideration set may include a list of application IDs and/or a list of application names.

The search module 212 may be further configured to perform a variety of different processing operations on the consideration set to obtain the organic search results 132. In some implementations, the search module 212 may generate a result score for each of the applications included in the consideration set. In some examples, the search module 212 may cull the consideration set based on the result scores of the applications contained therein. For example, the subset may be those applications having the greatest result scores or have result scores that exceed a threshold. The information conveyed in the search results 130 may depend on how the search module 212 calculates the result scores. For example, the result scores may indicate the relevance of an application to the search query 122, the popularity of an application in the marketplace, the quality of an application, and/or other properties of the application.

The search module 212 may generate result scores of applications in a variety of different ways. In general, the search module 212 may generate a result score for an application based on one or more scoring features. The search module 212 may associate the scoring features with the application and/or the query 122. An application scoring feature may include any data associated with an application. For example, application scoring features may include any of the application features included in the application record 234 or any additional parameters related to the application, such as data indicating the popularity of an application (e.g., number of downloads) and the ratings (e.g., number of stars) associated with an application. A query scoring feature may include any data associated with a search query 122. For example, query scoring features may include, but are not limited to, a number of words in the search query 122, the popularity of the search query 122 (e.g., the frequency at which users provide the same search query 122), and the expected frequency of the words in the search query 122. An application-query scoring feature may include any data, which may be generated based on data associated with both the application and the search query 122 (e.g., the query that resulted in the search module 212 identifying the application record 234 of the application). For example, application-query scoring features may include, but are not limited to, parameters that indicate how well the terms of the query match the terms of the identified application record 262. The search module 212 may generate a result score for an application based on at least one of the application scoring features, the query scoring features, and the application-query scoring features.

The search module 212 may determine a result score based on one or more of the scoring features listed herein and/or additional scoring features not explicitly listed. In some examples, the search module 212 may include one or more machine-learned models (e.g., a supervised learning model) configured to receive one or more scoring features. The one or more machine-learned models may generate result scores based on at least one of the application scoring features, the query scoring features, and the application-query scoring features. For example, the search module 212 may pair the query 122 with each application and calculate a vector of features for each (query, application) pair. The vector of features may include application scoring features, query scoring features, and application-query scoring features. The search module 212 may then input the vector of features into a machine-learned regression model to calculate a result score that may be used to rank the applications in the consideration set. The foregoing is one example manner by which the search module 212 can calculate a result score. According to some implementations, the search module 212 can calculate result scores in alternate manners.

The search module 212 may use the result scores in a variety of different ways. In some examples, the search module 212 may use the result scores to rank the applications in the consideration set and ultimately are included in the organic search results 132. In these examples, a greater result score may indicate that the application is more relevant to the search query 122 and/or the query parameters 124 than an application having a lesser result score. Additionally or alternatively, the search module 212 can cull the consideration set by removing applications from the consideration set that have result scores that do not exceed a minimum threshold. The search module 212 can include any remaining applications of the consideration set in the organic search results 132. In examples where the search results 130 are displayed as a list of application descriptions (e.g., an icon of an application and a description of the application) on a user device 100, the application descriptions associated with larger result scores may be listed nearer to the top of the displayed search results 130 (e.g., near to the top of the screen). In these examples, application descriptions having lesser result scores may be located farther down the displayed search results 130 (e.g., off screen) and may be accessed by a user scrolling down the screen of the user device 100 or viewing a subsequent page of search results 130. The search module 212 can provide the organic search results 132 to the API engine 200C. The API engine 200C (e.g., the API module 219) embeds the organic search results 132 into the search results 130.

The query categorizer 214 is configured to receive one or more of the query terms of the search query 122 and determine a query categorization 140 based on the query terms. The query categorization 140 can indicate one or more categories to which the search query 122 is likely to correspond. In some implementations, the categories are categories of applications.

In some implementations the search module 212 or the API engine 200C (e.g., the API module 219) processes the search query 122 to identify the relevant query terms and provides the relevant query terms to the advertising engine 200B. Additionally or alternatively, the advertising engine 200B (e.g., the query categorizer 214) can process the search query 122 to identify the relevant query terms. For example, the query categorizer 214 can identify the individual query terms of the search query 122, remove any stop words from the search query 122, and stem the individual query terms. The query categorizer 214 can perform any additional query processing. The resultant set of query terms can be referred to as the relevant query terms. In an example, the search query 122 may contain the query terms “games that are fun for my child.” The relevant query terms of the example search query 122 may be “game,” “fun,” and “child.”

For each relevant query term, the query categorizer 214 determines a term categorization for the relevant query term. A term categorization of a relevant query term can indicate one or more categories to which the relevant term is likely to correspond. In some implementations, the query categorizer 214 determines the term categorization for the relevant query term based on a category index 240. In some implementations, the category index 240 is an inverted index that has N terms as the keys to the index, whereby each term is indexed to one or more categories. In some implementations, the categories are application categories. Example application categories can include “lifestyle apps,” “organization apps,” “finance apps,” “popular games,” “addictive games,” “educational apps,” “music streaming apps,” “video streaming apps,” etc.

FIG. 2D illustrates an example of a category index 240. In the illustrated example, the category index 240 includes N terms, 242-1, 242-2, . . . , 242-N. The category index 240 may associate one or more categories 244 to each term 242. In some implementations, the set of categories 244 associating with a particular term are categories with which the particular term 242 has been used. According to these implementations, the first term 242-1 (of the category index 240 of FIG. 2D) has been used in connection with X different categories 244, the second term 242-2 has been used in connection with Y categories 244, and the Nth term has been used in connection with Z categories 244. In this example, X, Y, and/or Z can be, but do not have to be, equal values. In other implementations, the set of categories 244 associating to each term 242 includes all of the possible categories 244. In these implementations, X, Y, and Z are all equal to the number of categories 244 in the entire range of categories 244.

The category index 240 can further indicate statistics 245 that are indicative of how likely a term 242 is to be used in connection with each category 244 with which the term 242 is associated. In some implementations, each category 244 associated with a term 242 in the category index 240 may have one or more statistics 245 associated therewith. The statistics 245 are updated by the index builder 218 discussed in further detail below, and are specific to documents that the search system 200 (or a related system) collects and analyzes. Each document can include a block of text and may be assigned to one or more categories 244. In some implementations, a document can be application data corresponding to an application (e.g., an application description or an application review). Moreover, the categories 244 may be categories that are assigned to the application by, for example, a human or a machine learner. In an example, the set of documents may include {(“This is a fun game,” games), (“good game,” games), (“this is a great reader,” electronic reading devices)}. In this example there are three documents. The first two documents correspond to games and the third document corresponds to electronic reading devices.

The statistics 245 of a term 242 may include a total number of documents belonging to that category 244 that contain the term 242. The statistics 245 may further include a category mapping ratio that indicates a percent of all documents in the category index 240 that belong to the category 244. The statistics 245 can be used to calculate a frequency ratio 246 of the category 244 with respect to a term 242. The frequency ratio 246 of a category 244 with respect to a term 242 can indicate how likely it is that the term 242 may be used in connection with the category 244. Put another way, the frequency ratio 246 of a term 242 with respect to an application category 244 indicates a likelihood that the relevant term 242 pertains to the corresponding application category 244. For example, items such the term 242 “fun” may be used quite frequently with popular games, addictive games, and educational apps. The term 242 may be used less frequently with finance apps. Thus in an example, the frequency ratios 246 for the categories 244 popular games as used in connection with the term 242 “fun” are likely to be greater than the frequency ratio 246 of the category finance apps, as used in connection with the term 242 “fun.” For example, the frequency ratio 246 of the category 244 “popular games” used in connection with the term 242 “fun” may be 0.63. The frequency ratio 246 of the category 244 “addictive games” used in connection with the term 242 “fun” may be 0.75. The frequency ratio 246 of the category 244 “educational apps” used in connection with the term 242 “fun” may be 0.4. The frequency ratio 246 of the category 244 “finance apps” used in connection with the term 242 “fun” may be 0.00. In some implementations, the statistics 245 can include other metrics, such as an inverse document frequency of the term 242.

In some implementations, the query categorizer 214 determines the frequency ratio of each category 244 with respect to a relevant term at query time. Additionally or alternatively, the index builder 218 may calculate the frequency ratios 246 at build time. In these implementations, the index builder 218 may calculate the frequency ratios for each category 244 with respect to each term 242 in the category index 240, and may update the category index 240 each time a new document or batch of documents are obtained and analyzed. In these implementations, the index builder 218 can store the calculated frequency ratios 246 in the category index 240 and the query categorizer 214 can retrieve the frequency ratio of a term 242 with respect to a particular category 244 from the category index 240 at query time. The frequency ratio of a category C can be calculated using equation (2):

$$Frequency Ratio ( C ) = {( \frac{\frac{Cat Docs}{Total Docs}}{Category Ratio} )}^{i} \qquad ( 2 )$$

where Cat Docs is the number of documents corresponding to the category C that contain the relevant term 242, Total Docs is the number of documents in any category 244 that contain the relevant term 242, Category Ratio is the category ratio mapping of the category C, and i is a number greater than or equal to 1. In some implementations, i is equal to two. The category ratio mapping indicates the amount of documents corresponding to a particular category 244 in relation to the total amount of documents.

Each term 242 in the category index 240 may index to any category 244 that the term 242 is used in connection with. Put another way, each term 242 in the category index 240 may be indexed to any category 244 that has a frequency ratio 246 that is greater than zero when used in connection with the term 242. Alternatively, each term 242 may be indexed to all categories 244, even categories 244 that the term 242 has not been used in connection with (i.e., categories 244 having frequency ratios 246 equal to zero).

The query categorizer 214 can determine the term categorizations for each of the relevant query terms in the search query 122 based on the category index 240. In some implementations a term categorization can be expressed as a linear combination of ratio scores of the different categories. For example, the linear combination of a relevant query term may be expressed with the following equation:

Sub_Categorization(T)=FR₁C₁+FR₂C₂+ . . . FR_{N}C_{N} (3)

where T is the term and FRᵢ is the frequency of the ith category, Cᵢ. In implementations where the category index 240 does not contain frequency ratios 246 for categories 244 which are not used in connection with a particular term 242, the query categorizer 214 can provide a dummy frequency ratio 246 for the unrepresented categories 244 and may assign a value of zero to each dummy frequency ratio 246 in the linear combination expressed in equation (3). In this way, any term categorization will have frequency ratios 246 assigned to any possible category 244, even categories 244 which are not used with the corresponding relevant term 242. In some implementations, the query categorizer 214 normalizes the frequency ratios 246 of each term categorization between two values (e.g., between 0 and 1). In some implementations, each term categorization can be represented in a vector, where the elements of the vector represent different categories 244 and the values assigned to the elements of the vector are the frequency ratios 246 of the different categories 244.

In some implementations, the category index can be further organized into first level categories 244 and second level categories 244. First level categories 244 are broader categories 244 to which one or more second level categories 244 correspond. For example, a first level category 244, “games,” can include the second level subcategories of “strategy games,” “word games,” and “board games.” Similarly, a first level category 244 “health and fitness” can include the second level categories 244 “diet and nutrition,” “fitness,” and “health.” In these implementations, the data stored in the index (e.g., frequency ratio 246 or statistics 245) can correspond to the second level categories 244, rather than the broader first level categories 244. Furthermore, in these implementations, the query categorizer 214 can determine the term categorizations for the second level categories 244 rather than the first level categories 244. In some scenarios, however, some first level categories 244 may not be as granular as others. For example, the first level application “productivity” or “education” may not include any second level categories 244. In such a scenario, the frequency ratios 246 and/or statistics 245 of a term 242 can be associated to the first level category 244 and the query categorizer 214 utilizes the first level category metrics to determine the term categorizations. Put another way, the query categorizer 214 can operate on the deepest categories 244 possible in the category index 240. Thus, drawing from the examples above, if a term 242 in the search query 122 is “challenging,” the term categorization can include frequency ratios 246 for the categories 244 “strategy games” (second level), “word games” (second level), “board games” (second level), “diet and nutrition” (second level), “fitness” (second level), “health” (second level), “productivity” (first level), and “education.”

The query categorizer 214 can determine a query categorization 140 by combining the term categorizations. In some implementations, the query categorizer 214 combines each of the relevant frequency terms 242 (determined using equation (2)). In some implementations the query categorizer 214 can determine the query categorization 140 according to:

Categorization=Σᵢ₌₁^{M}Subcategorization(Tᵢ) (4)

where M is the total number of relevant terms 242 in the search query 122 and Tᵢ is the ith relevant term 242 of the search query 122. The result of equation (4) can be represented by equation (1) or a vector. In some implementations the query categorizer 214 normalizes the category scores of each category 244 in equation (4) to obtain the query categorization 140. In some implementations, the term categorization for each term 242 may be adjusted based on a metric associated with the term 242. In some of these implementations, the term categorization of a term 242 may be multiplied by the inverse document frequency of the term 242. In these implementations, the categorization can be determined according to equation (5):

Categorization=Σᵢ₌₁^{M}IDF(Tᵢ)*Subcategorization(Tᵢ) (5)

where IDF(Tᵢ) is the inverse document frequency of the ith term 242. The query categorizer 214 can calculate the inverse document frequency at query time. Alternatively, the query categorizer 214 can look up the inverse document frequency of each term 242 from the statistics 245 stored in the category index 240.

The query categorizer 214 can calculate the categorizations in any other suitable manner. For instance, the query categorizer 214 can provide greater significance to occurrences of terms 242 when the terms 242 are included in a title or description of an application, as opposed to a review of the application. For example, if the term 242 “board games” is found in a title of an application, the occurrence of the term 242 may be weighted more heavily than if found in the description of the application or a review of the application.

The advertisement generation module 216 receives the query categorization 140 and generates one or more advertisements 134 to include in the search results 130. In some implementations, the advertisement generation module 216 determines which advertisements 134 to include in the search results 130 based on the query categorization 140 and the advertisement data store 236.

The advertisement data store 236 may include one or more databases, indices (e.g., inverted indices), files, or other data structures storing this data. In some implementations, the advertisement data store 236 includes an advertisement index 238 and one or more advertisement records 239. The advertising index 238 may include categories 244 as keys to advertisement records 239. FIG. 2E illustrates an example of the advertisement index 238. The advertisement index 238 can include P categories 244. Each category 244 indexes to one or more advertisement records 239. A particular category 244 indexes to an advertisement record 239 if the advertising entity has agreed to a fee structure that implicates the category 244. For example, if the advertising entity wishes to advertise a gaming application with respect to the category “addictive games” and agrees to a particular fee structure, the addictive games category 244-1 entry in the advertising index 238 indexes to an advertisement record 239-1 corresponding to the advertising entity.

An advertisement record 239 stores advertisement content and the fee structure to which the advertising entity agreed. For example, if the advertising entity agrees to pay one cent per impression to display an advertisement 134 with respect to the category 244 popular games, the advertisement record 239 can indicate that agreement to the fee structure or the terms of the fee structure and the advertisement content that is to be displayed in the search results 130.

Advertisement content may include data that the advertisement generation module 216 uses to generate an advertisement 134 for inclusion in the search results 130. For example, advertisement content may include text associated with a sponsored subject (e.g., a sponsored application or a sponsored website), such as a description of the subject and/or marketing of the subject. In some examples, the advertisement content may further include text indicating to a user that the advertisement 134 is an advertisement for the subject, instead of an organic search result 132. For example, the advertisement content may include text, such as “Sponsored Application,” “Sponsored Result,” or “Advertisement.” The advertisement content may also include images, animations, and videos associated with the sponsored subject. The advertisement content may also include links to locations associated with the sponsored subject. For example, the link may include a web resource identifier to a website. In other scenarios, a link can include an application resource identifier to a digital distribution platform that distributes a sponsored application or to a state of a sponsored application.

In operation, the advertisement generation module 216 can retrieve one or more advertisement records 239 based on the query categorization 140 and can generate one or more advertisements 134 based on the one or more advertisement records 239. In some implementations, the advertisement generation module 216 selects the category 244 in the query categorization 140 having the highest weight associated therewith. In other implementations, the advertisement generation module 216 selects the categories 244 having a score above a threshold (e.g., any category 244 in the query categorization having a category score greater than 0.7). The advertisement generation module 216 can retrieve one or more advertisement records 239 based on the selected category 244 or categories 244 and the fee structures indicated in the advertisement records 239. For instance, the advertisement generation module 216 can select, from the advertisement records 239 associated to the selected category 244, the advertisement record 239 or records 239 having the most lucrative fee structure (e.g., the advertisement record 239 of the advertising entity that agreed to pay the greatest amount per event). From each selected advertisement record 239, the advertisement generation module 216 generates an advertisement 134 to be included in the search results 130. The advertisement generation module 239 can provide one or more generated advertisements 134 to the API engine 200C, which can embed the advertisements 134 in the search results 130.

The index builder 218 builds and maintains the one or more category indexes 240. The index builder 218 receives a set of documents and generates the category index 240 based on the set of documents. As previously discussed, documents can refer to blocks of text that have been associated with a particular category (and possibly a particular application). In an example provided above, a set of documents may include {(“This is a fun game,” games), (“good game,” games), (“this is a great reader,” electronic reading devices)}. In this example there are three documents. The first two documents correspond to games and the third document corresponds to electronic reading devices.

The index builder 218 parses each document to identify each unique term in the document. In some implementations, the index builder 218 can remove the stop words and stem the remaining terms 242 before identifying the unique terms 242. Drawing from the example above, the index builder 218 may identify the following unique terms 242 from the three documents:
“fun”: {games: 1, electronic reader applications: 0}
“game”: {games: 2, electronic reader applications: 0}
“good”: {games: 1, electronic reader applications: 1}
“reader”: {games: 0, electronic reader applications: 1}

The index builder 218 may further calculate a category ratio mapping. The category ratio mapping indicates the amount of documents corresponding to a particular category 244 in relation to the total amount of documents. In the illustrated example (assuming three total documents), the category ratio mapping is {games: 0.667, electronic reader applications: 0.333}.

The index builder 218 can generate an inverted index for each unique term 242. For each unique term 242, the index builder 218 can determine the statistics 245 for each category 244 with respect to the unique term 242. The index builder 218 can store the statistics 245 for each category 244 with respect to the unique term 242 in the category index 240 (e.g., how many documents corresponding to a particular category 244 contain the unique term 242 and/or an inverse document frequency of the term 242). The index builder 218 can also calculate the frequency ratio 246 of the category 244 and store the frequency ratio 246 of the category 244 in the category index 240. In some implementations, the index builder 218 calculates a frequency ratio 246 for each of the predetermined categories 244 with respect to each unique term 242. In some implementations, the index builder 218 can calculate the frequency ratio 246 for each of the categories 244 with respect to a particular term 242 using, for example, equation (2), described above. The index builder 218 can store each calculated frequency ratio 246 in the category index 240 with respect to the term 242/category 244 combination corresponding to the calculated frequency ratio 246.

The index builder 218 is further configured to update the category index 240 each time the search system 200 receives a new document or a batch of new documents to index. Documents may be collected by one or more crawlers that crawl websites and digital distribution platforms. The index builder 218 receives a new document and a category 244 classification corresponding to the document. The index builder 218 can process the new document to identify the relevant terms 242 contained in the new document. For each unique relevant term 242 in the new document, the index builder 218 can update the statistics 245 in the category index 240 for the relevant term 242. The index builder 218 can also update the category mappings for each category 244, as the addition of one document to the total set of documents alters the total number of documents. In some implementations, the index builder 218 calculates new frequency ratios 246 for each term 242/category 244 combination in the category index 240 because of the newly added documents likely affect each frequency ratio 246, even if a particular category 244 or term 242 was not implicated by the new document. The index builder 218 can utilize equation (2) to determine the updated frequency ratios 246.

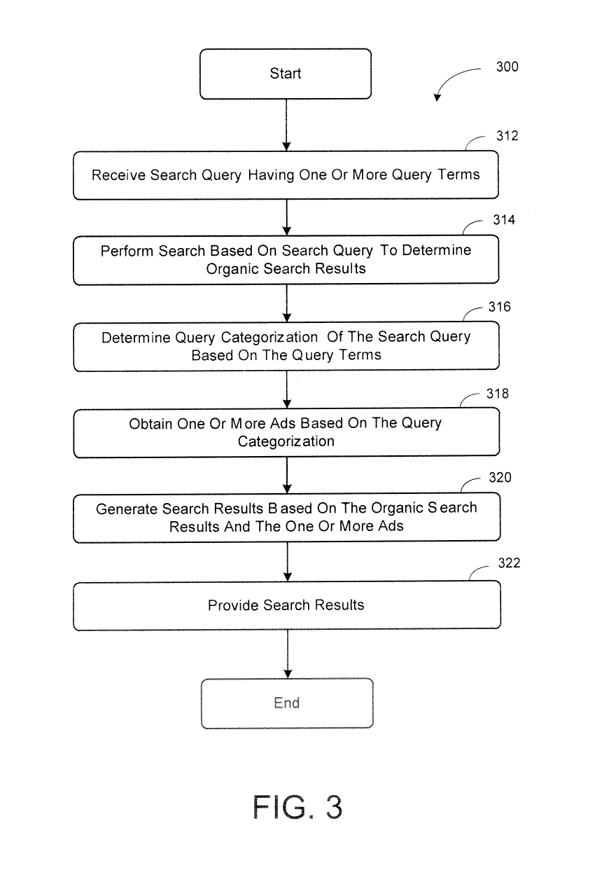

FIG. 3 illustrates an example set of operations for a method 300 for processing a search query 122. The method 300 may be executed by the components of the search system 200 described with respect to FIG. 2. For purposes of explanation, the search system 200 is described as an application search system that outputs search results 130 indicating applications relevant to the search query 122. The techniques described below may be applied to any other suitable type of search.

At operation 312, the API engine 200C (e.g., the API module 219) receives a search query 122. In some implementations, the API engine 200C receives a query wrapper 120 that contains the search query 122 and one or more query parameters 124. The API engine 200C can parse the query wrapper 120 to identify the search query 122 and the one or more query parameters 124.

At operation 314, the search module 212 performs a search based on the search query 122 to determine the organic search results 132. In some implementations the query module 212 performs a function based application search, which is described in greater detail above. The search module 132 can identify a consideration set that indicates a list of application records 234 based on the search query 122 and/or the one or more query parameters 132. Each application record 234 indicates an application that is relevant to the search query 122 and/or one or more of the query parameters 124. The search module 212 can process the consideration set to obtain the organic search results 132. For example, the search module 212 can calculate results scores for each of the applications indicated in the consideration set, rank the applications in the consideration set based on the results scores, and/or cull the consideration set based on the results scores. Of the applications indicated in the consideration set after ranking and culling, the search module 212 generates result objects based on the application records 234 of the remaining records. The search module 212 may perform any other type of search. In some implementations, the search module 212 provides the organic search results 132 to the API engine 200C.

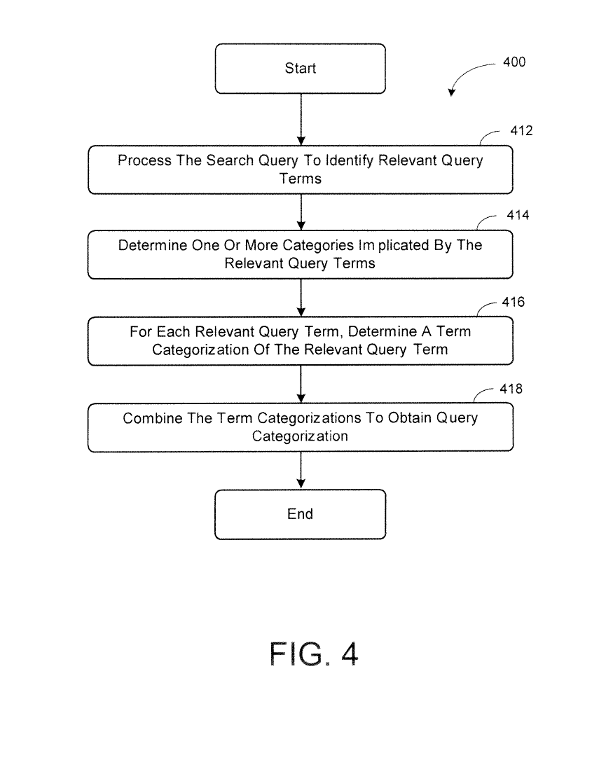

At operation 316, the query categorizer 214 determines a query categorization 140 of the search query 122 based on the relevant query terms of the search query 122. FIG. 4 illustrates an example set of operations for a method 400 for determining a query categorization 140. At operation 412, the query categorizer 214 processes the search query 122 to identify the relevant query terms. The query categorizer 214 can parse the search query 122 and remove any stop words from the search query 122. Additionally or alternatively, the query categorizer 214 can stem the query terms. The query categorizer 214 can perform other query analysis techniques, such as synonomization, tokenization, and/or filtering to obtain the relevant query terms. In some implementations, the search module 212 or the API engine 200C (e.g., the API module 219) can parse and process the search query 122 to obtain the relevant query terms. In these implementations, the search module 212 or the API engine 200C (e.g., the API module 219) can pass the relevant query terms to the query categorizer 214.

At operation 414, the query categorizer 214 can determine one or more categories 244 implicated by the relevant query terms. The query categorizer 214 can determine one or more categories 244 implicated by each relevant query term using the category index 240. For a relevant query term, the query categorizer 214 can query the category index 240 with the relevant query term to obtain the categories 244 associated with the relevant query term.

At operation 416, the query categorizer 214 can determine a term categorization for each relevant query term. The query categorizer 214 may obtain statistics 245 corresponding to each relevant term 242/category 244 combination or a frequency ratio 246 for each relevant term 242/category 244 combination from the category index 240. In the former implementations, the query categorizer 214 calculates the frequency ratio 246 for each relevant term 242/category 244 combination using the statistics 245 corresponding to the combination and equation (2), as discussed above. In some implementations, the query categorizer 214 determines a linear combination of frequency ratios 246 for each of the categories 244 corresponding to the relevant query term. As described above, the query categorizer 214 generates a linear combination for the relevant query term based on the frequency ratios 246. The query categorizer 214 may further include a dummy score of 0.00 for each category 244 that is not implicated by the query term and does not appear with respect to the relevant query term in the category index 240. The linear combination of each relevant query term can be expressed using equation (3) or by a vector. For example, take a search query 122 of “fun with organizing” and the possible categories consist of the group C₁=“games,” C₂=“lifestyle,” and C₃=“accounting.” In this example, the term categorization of the term 242 “fun” may be:

Subcategorization(fun)=0.7C₁+0.4C₂+0.0C_{N}

and the term categorization of the term 242 “organize” may be:

Subcategorization(organize)=0.1C₁+0.7C₂+0.6C_{N}

Additionally or alternatively, the term categorization may be represented by Term categorization(fun)=<0.7, 0.4, 0> and Term categorization (organize)=<0.1, 0.7, 0.6>.

At operation 418, the query categorizer 214 combines the term categorizations of the relevant query terms to obtain a query categorization 140 for the search query 122. The query categorizer 214 can combine the linear combinations according to equation (4), as described above. Drawing from the example of the search query 122 of “fun with organizing,” the query categorizer 214 can output a query categorization 140 of:

Categorization=0.8C₁+1.1C₂+0.6C₃

Additionally or alternatively, the term categorization may be represented by Categorization(fun)=<0.8, 1.1, 0.6>. In some implementations, the query categorizer 214 normalizes the category scores (or weights) in the query categorization 140 to values between zero and an upper value (e.g., one).

Referring back to FIG. 3, at operation 318 the advertisement generation module 216 generates one or more advertisements 134 based on the query categorization 140. The advertisement generation module 216 identifies one or more categories 244 from the query categorization 140 based on the category scores of each category 244 indicated in the query categorization 140. In some implementations, the advertisement generation module 216 selects the category 244 or categories 244 having the highest category score or scores in the query categorization 140. The advertisement generation module 216 identifies one or more advertisement records 239 corresponding to the selected category 244. In some implementations, the advertisement generation module 216 queries the advertisement index 238 with the selected category 244 to determine one or more advertisement records 239 that have been associated to the selected category 244. The advertisement generation module 216 selects one or more advertisement records 239 it will utilize to generate one or more advertisements 134 based on the agreed upon fee structures indicated in the advertisement records 239 associated with the selected category 244. In some implementations, the advertisement generation module 216 can select the advertisement record 239 that indicates the greatest value (i.e., the highest agreed upon price per event) provided that the advertising entity corresponding to the advertisement record 239 has not exceeded its agreed upon budget for a particular time period. For example, if a first advertisement record 239 indicates that a first advertising entity is willing to pay two cents per impression and a second advertisement record 239 indicates that the second advertising entity agrees to pay one cent per impression, the advertisement generation module 216 selects the first advertisement record 239 to generate an advertisement 134. If, however, the fee structure in the first advertisement record 239 limits the total amount of advertising costs for a single day to $100, and that advertising entity has already been charged $100 for that day, then the advertisement generation module 216 can select the second advertisement record 239 to generate the advertisement 134. The advertisement generation module 216 can select the advertisement record 239 according to the fee structure in other suitable manners as well. The advertisement generation module 216 can generate an advertisement 134 based on the advertisement content stored in the advertisement record 239. The advertisement generation module 216 can generate sponsored result objects using, for example, a template or commands for generating the result object and the descriptions, icons, screenshots, and/or resource identifiers contained in the advertisement content. The advertisement generation module 216 can provide the one or more sponsored result objects (i.e., advertisements 134) to the API module 200C.

At operation 320, the API engine 200C (e.g., the API module 219) generates search results 130 based on the organic search results 132 and one or more advertisements 134 generated by the advertisement generation module 216. The API engine 200C (e.g., the API module 219) may combine the organic search results 132 with the advertisements 134 to obtain the search results 130. API engine 200C (e.g., the API module 219) can utilize a template or commands to generate the search results 130. In some implementations, the API engine 200C (e.g., the API module 219) generates code (e.g., interpreted code) containing the search results that the user device 100 executes to display the search results 130. At operation 322, the API engine 200C (e.g., the API module 219)transmits the search results 130 to the requesting user device 100.

The methods 300, 400 of FIGS. 3 and 4 are provided for example. Variations of the methods 300, 400 may be considered within the scope of the disclosure. Further, the query categorization 140 can be utilized in additional or alternative processes. For instance, the query categorization 140 can be provided to the search engine 200B to be used as an additional query feature by the machine learned scoring models.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, by one or more processing devices, a search query containing one or more query terms from a remote computing device;
determining, by the one or more processing devices, a query categorization of the search query based on one or more relevant query terms of the one or more query terms, the query categorization being indicative of one or more application categories to which the search query likely pertains;
generating, by the one or more processing devices, an advertisement based on the query categorization;
encoding, by the one or more processing devices, the advertisement in search results; and
providing, by the one or more processing devices, the search results to the remote computing device.

2. The method of claim 1, further comprising:
determining, by the one or more processing devices, organic search results indicating one or more applications relevant to the search query; and
encoding, by the one or more processing devices, the organic search results in the search results.

3. The method of claim 1, wherein determining the query categorization includes:
identifying the one or more relevant terms from the one or more relevant query terms;
for each of the one or more relevant query terms, determining a term categorization of the relevant query term, each term categorization indicating one or more frequency ratios respectively corresponding to the one or more application categories, each frequency ratio being indicative of a degree of likelihood that the relevant query pertains to the corresponding application categories; and
determining the query categorization based on the one or more term categorizations corresponding to the one or more relevant query terms.

4. The method of claim 3, wherein determining the term categorization of the relevant query term includes calculating the one or more frequency ratios for the relevant query terms based on a number of documents associated with the corresponding application category, a number of documents associated with any application category that contains the relevant term, and a category ratio mapping of the corresponding application category.

5. The method of claim 4, wherein each frequency ratio is calculated using:
$$Frequency Ratio ( C ) = {( \frac{\frac{Cat Docs}{Total Docs}}{Category Ratio} )}^{i}$$
where Cat Docs is the number of documents associated with an application category C that contain the relevant term, Total Docs is the number of documents associated with any category that contain the relevant term, Category Ratio is the category ratio mapping of the category C, and i is a number greater than or equal to 1.

6. The method of claim 4, wherein determining the plurality of frequency ratios includes:
for each of a plurality of application categories including the one or more application categories, retrieving a frequency ratio from a category index, wherein the category index associates each of a plurality of unique terms with the plurality of application categories, and stores a corresponding frequency score for each unique term and application category combination.

7. The method of claim 4, wherein determining the query categorization includes combining the term categorizations of each of the relevant query terms.

8. The method of claim 1, wherein generating the advertisement based on the query categorization includes:
retrieving an advertisement record based on the category categorization, the advertisement record being associated with an application category of a plurality of application categories and including advertisement content corresponding to a sponsored subject; and
generating the advertisement based on the advertisement content.

9. The method of claim 8, wherein retrieving the advertisement record includes:
identifying one or more application records corresponding to an application category of the one or more categories from a plurality of application records, the application category being the most likely of the one or more application categories to pertain to the search query; and
selecting the advertisement record from the one or more application records based on fee structures of the one or more advertisement records, each of the plurality of advertisement records having a fee structure indicating an agreed upon price per event.

10. The method of claim 1, wherein the query categorization includes a plurality of category scores, each category score of the plurality of category scores respectively corresponding to one of a plurality of application categories and indicating a likelihood that the search query pertains to the corresponding application category.

11. A search system comprising:
one or more storage devices;
one or more processing devices that executes computer readable instructions, the computer readable instructions, when executed by the one or more processing devices, causing the one or more processing devices to:
receive a search query containing one or more query terms from a remote computing device;
determine a query categorization of the search query based on one or more relevant query terms of the one or more query terms, the query categorization being indicative of one or more application categories to which the search query likely pertains;
generate an advertisement based on the query categorization;
encode the advertisement in search results; and
provide the search results to the remote computing device.

12. The search system of claim 11, wherein the computer readable instructions further cause the processing device to:
determine organic search results indicating one or more applications relevant to the search query; and
encode the organic search results in the search results.

13. The search system of claim 11, wherein determining the query categorization includes:
identifying the one or more relevant terms from the one or more relevant query terms;
for each of the one or more relevant query terms, determining a term categorization of the relevant query term, each term categorization indicating one or more frequency ratios respectively corresponding to the one or more application categories, each frequency ratio being indicative of a degree of likelihood that the relevant query pertains to the corresponding application categories; and
determining the query categorization based on the one or more term categorizations corresponding to the one or more relevant query terms.

14. The search system of claim 13, wherein determining the term categorization of the relevant query term includes calculating the one or more frequency ratios for the relevant query terms based on a number of documents associated with the corresponding application category, a number of documents associated with any application category that contains the relevant term, and a category ratio mapping of the corresponding application category.

15. The search system of claim 14, wherein each frequency ratio is calculated using:
$$Frequency Ratio ( C ) = {( \frac{\frac{Cat Docs}{Total Docs}}{Category Ratio} )}^{i}$$
where Cat Docs is the number of documents associated with an application category C that contain the relevant term, Total Docs is the number of documents associated with any category that contain the relevant term, Category Ratio is the category ratio mapping of the category C, and i is a number greater than or equal to 1.

16. The search system of claim 14, wherein the storage device stores a category index that associates each of a plurality of unique terms with a plurality of application categories including the one or more application categories and stores a corresponding frequency score for each unique term and application category combination; and
wherein determining the plurality of frequency ratios includes, for each of the plurality of application categories, retrieving a frequency ratio corresponding to the relevant query term from a category index.

17. The search system of claim 14, wherein determining the query categorization includes combining the term categorizations of each of the one or more relevant query terms.

18. The search system of claim 11, wherein the one or more storage devices store an advertisement datastore that stores a plurality of advertisement records, each advertisement record being associated with an application category of a plurality of application categories and including advertisement content corresponding to a sponsored subject; and
wherein generating the advertisement based on the query categorization includes:
retrieving an advertisement record from the plurality of advertisement records based on the category categorization; and
generating the advertisement based on the advertisement content.

19. The search system of claim 18, wherein retrieving the advertisement record includes:
identifying one or more application records from the advertisement datastore, each application record corresponding to an application category of the one or more categories, the application category being the most likely of the one or more application categories to pertain to the search query; and
selecting the advertisement record from the one or more application records based on fee structures of the one or more advertisement records, each of the plurality of advertisement records having a fee structure indicating an agreed upon price per event.

20. The search system of claim 11, wherein the query categorization includes a plurality of category scores, each category score of the plurality of category scores respectively corresponding to one of a plurality of application categories and indicating a likelihood that the search query pertains to the corresponding application category.
